(19) United States
(12) Patent Application Publication
(10) Pub. No.: US 2026/0268685 A1
(43) Pub. Date: Sep. 10, 2026

(54) EXTENDING RANGE FOR LIDAR-BASED 3D PERCEPTION PIPELINES

(71) Applicant: QUALCOMM Incorporated, San Diego, CA (US)

(72) Inventors: Andrei Stefan Bulzan, Timisoara (RO); Kiran Bangalore Ravi, Paris (FR); Senthil Kumar Yogamani, San Diego, CA (US)

(21) Appl. No.: 19/075,611

(22) Filed: Mar. 10, 2025

(51) Int. Cl. G06V 20/58; G01S 17/931; G06V 10/774; G06V 20/70

(52) U.S. Cl. CPC G06V 20/58; G06V 10/774; G06V 20/70; G01S 17/931

(57) ABSTRACT

A method comprising: obtaining point cloud data indicating positions of points relative to a first origin point; initializing a plurality of second origin points; for each of the second origin points and for each point of the plurality of points, identifying the point as being in the point subset for the second origin point based on a distance of the point from the second origin point being less than a second distance threshold; modify the points in the point subset so that the coordinate data for the points indicate the positions of the points relative to the second origin point instead of the first origin point; and applying an object recognition model to the modified points in the point subset for the second origin point to generate object labels for the modified points; and generating an aggregated label map based on the object labels for the modified points.

### TECHNICAL FIELD

This disclosure relates to systems for image processing.

### BACKGROUND

Autonomous navigation and advanced driver-assistance systems (ADAS) are increasingly important features of vehicles. In general, these technologies involve generating a model of the environment of the vehicle based on sensor data generated by sensors positioned on the vehicle. These sensors, which may include cameras, radars, and light detection and ranging (LIDAR) systems, provide diverse types of data that need to be integrated effectively to ensure accurate perception and navigation. Traditional methods often involve projecting sensor data onto a Bird's Eye View (BEV) grid, which maps the vicinity of the vehicle.

### SUMMARY

In general, this disclosure describes techniques for processing sensor data. A processing system of a vehicle may obtain point cloud data based on data generated by a LIDAR system that is configured to sense objects within a given range of distances. The processing system may then apply an object recognition model to the point cloud data to generate object labels for points in the point cloud data. For example, the object labels may indicate that individual points are associated with a stop sign, a lane marker, a pedestrian, or another type of object. Extensive effort has gone into training object recognition models. However, LIDAR systems have improved in recent years, allowing for LIDAR systems to sense objects at greater distances than distances used for training the object recognition models. Thus, the object recognition models may be unable to use point clouds generated based on data generated from newer, longer-range LIDAR systems. Retraining object recognition models may be expensive. Additionally, object recognition models trained for longer-range LIDAR systems may be more complex, more computationally demanding, and consume more energy than object recognition models for shorter-range LIDAR systems.

This disclosure describes techniques that may address this issue. As described herein, a computing system may obtain point cloud data comprising coordinate data for a plurality of points. The point cloud data may be generated based on data from a long-range LIDAR system. For each point of the plurality of points, the coordinate data for the point indicates of a position of the point relative to a first origin point, and a distance of the point from the first origin point is less than a first distance threshold. Additionally, the computing system may initialize a plurality of second origin points. For each second origin point of the plurality of second origin points, the computing system may identify a point subset for the second origin point. As at least part of identifying the point subset for the second origin point, the computing system may, for each point of the plurality of points, identify the point as being in the point subset for the second origin point based on a distance of the point from a second origin point being less than a second distance threshold. The second distance threshold is less than the first distance threshold. Additionally, for each second origin point of the plurality of second origin points, the computing system may modify the points in the point subset for the second origin point so that the coordinate data for the points in the point subset for the second origin point indicate the positions of the points in the point subset for the second origin point relative to the second origin point instead of the first origin point. The computing system may apply an object recognition model to the modified points in the point subset for the second origin point to generate object labels for the modified points in the point subset for the second origin point. The computing system may then generate an aggregated label map based on the object labels for the modified points in the point subsets for the plurality of second origin points. By using point subsets in this way, the computing system may be able to use an object recognition model that is trained to generate object labels for point clouds having maximum distances less than or equal to the second distance threshold.

In one example, this disclosure describes a method of a computer-implemented method comprising: obtaining point cloud data comprising coordinate data for a plurality of points, wherein, for each point of the plurality of points: the coordinate data for the point indicates of a position of the point relative to a first origin point, and a distance of the point from the first origin point is less than a first distance threshold; initializing a plurality of second origin points, at least one of the plurality of second origin points being different from the first origin point; updating the plurality of second origin points to increase an aggregate coverage region of the second origin points within a coverage region of the first origin point; for each second origin point of the plurality of second origin points: identifying a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modifying the points in the point subset for the second origin point so that the coordinate data for the points in the point subset for the second origin point indicate the positions of the points in the point subset for the second origin point relative to the second origin point instead of the first origin point; and applying an object recognition model to the modified points in the point subset for the second origin point to generate object labels for the modified points in the point subset for the second origin point; and generating an aggregated label map based on the object labels for the modified points in the point subsets for the plurality of second origin points.

In another example, this disclosure describes a system comprising: one or more memories configured to store point cloud data comprising coordinate data for a plurality of points, wherein, for each point of the plurality of points: the coordinate data for the point indicates of a position of the point relative to a first origin point, and a distance of the point from the first origin point is less than a first distance threshold; and one or more processors configured to: initialize a plurality of second origin points, at least one of the plurality of second origin points being different from the first origin point; update the plurality of second origin points to increase an aggregate coverage region of the second origin points within a coverage region of the first origin point; for each second origin point of the plurality of second origin points: identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modify the points in the point subset for the second origin point so that the coordinate data for the points in the point subset for the second origin point indicate the positions of the points in the point subset for the second origin point relative to the second origin point instead of the first origin point; and apply an object recognition model to the modified points in the point subset for the second origin point to generate object labels for the modified points in the point subset for the second origin point; and generate an aggregated label map based on the object labels for the modified points in the point subsets for the plurality of second origin points.

In another example, this disclosure describes one or more non-transitory computer-readable storage media having instructions stored thereon that, when executed by one or more processors, cause the one or more processors to: obtain point cloud data comprising coordinate data for a plurality of points, wherein, for each point of the plurality of points: the coordinate data for the point indicates of a position of the point relative to a first origin point, and a distance of the point from the first origin point is less than a first distance threshold; initialize a plurality of second origin points, at least one of the plurality of second origin points being different from the first origin point; update the plurality of second origin points to increase an aggregate coverage region of the second origin points within a coverage region of the first origin point; for each second origin point of the plurality of second origin points: identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modify the points in the point subset for the second origin point so that the coordinate data for the points in the point subset for the second origin point indicate the positions of the points in the point subset for the second origin point relative to the second origin point instead of the first origin point; and apply an object recognition model to the modified points in the point subset for the second origin point to generate object labels for the modified points in the point subset for the second origin point; and generate an aggregated label map based on the object labels for the modified points in the point subsets for the plurality of second origin points.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an example vehicle that may be configured to perform tasks in accordance with one or more techniques of this disclosure.

FIG. 2 is a block diagram illustrating an example computing system configured in accordance with one or more techniques of this disclosure.

FIG. 3 is a conceptual diagram illustrating example coverages regions associated with a first origin point and a plurality of second origin points, in accordance with one or more techniques of this disclosure.

FIG. 4 is a flowchart illustrating an example operation of a recognition system configured in accordance with one or more techniques of this disclosure.

FIG. 5 is a flowchart illustrating an example operation for updating positions of second origin points, in accordance with one or more techniques of this disclosure.

### DETAILED DESCRIPTION

This disclosure describes techniques that may be used for extending ranges of LIDAR-based 3-dimensional (3D) perception pipelines. As described herein, an object recognition model may be trained to recognize objects based on point cloud data representing points within a first radius of a LIDAR system. However, with advancements in LIDAR technology, LIDAR systems may be able to detect objects at a second radius that is greater than the first radius. Retraining the object recognition system may be costly and may significantly add to the complexity of the object recognition system. The techniques of this disclosure may avoid retraining or reconfiguration of the object recognition system while allow object recognition for objects within the second radius.

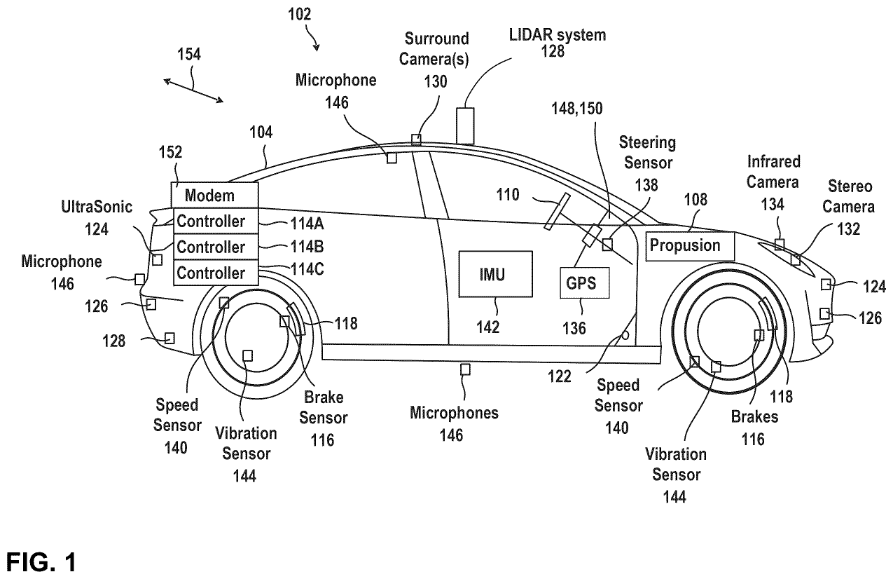

FIG. 1 shows an example vehicle 102 that may be configured to perform tasks in accordance with one or more techniques of this disclosure. Vehicle 102 may comprise a passenger vehicle such as a car, trucks, buses, trains, and another type of vehicles that can accommodate a human driver and/or human passengers. In some examples, vehicle 102 comprises an autonomous vehicle or semi-autonomous vehicle. In this disclosure, references to vehicles may also apply with respect to robots and other types of machines or apparatuses.

Vehicle 102 may include an ADAS. Vehicle 102 may include a vehicle body 104 coupled to a chassis. In this example, the chassis comprises four wheels and associated axles. In other examples, the chassis may include other numbers of wheels and axles. Vehicle 102 includes a propulsion system 108, such as an internal combustion engine, hybrid electric power plant, all-electric engine, or another type of machine for providing motive power to drive some or all of the wheels via a drive train. The drive train may include a transmission (not shown). A steering wheel 110 may be used to steer some or all of the wheels to direct vehicle 102 along a desired path when propulsion system 108 is operating and engaged to propel vehicle 102. Steering wheel 110 or the like may be optional for Level 5 implementations. One or more controllers 114A-114C (collectively, “controller system 114”) may provide autonomous capabilities in response to signals continuously provided in real-time from an array of sensors, as described more fully below.

Controller system 114 may include one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, and controller 114C may provide artificial intelligence functionality for in-camera sensors. In some examples, another controller (not shown) may provide infotainment functionality and provide additional redundancy for emergency situations.

Controller system 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”). The CAN bus is a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine rotations-per-minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the CAN bus of vehicle 102 and controller system 114, forwarding vehicle data to controller system 114 including the turn signal, wheel speed, acceleration, pitch, roll, yaw, Global Positioning System (“GPS”) data, tire pressure, fuel level, Sound Navigation and Ranging (SONAR), brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller system 114 may provide autonomous driving outputs in response to an array of sensor inputs from the following sensors, including, for example: one or more ultrasonic sensors 124 (e.g., a SONAR sensor), one or more RADAR sensors 126, a LIDAR system 128, one or more surround cameras 130 (typically such cameras are located at various places on vehicle body 104 to image areas all around the vehicle body), one or more cameras 132 (in one example, at least one such camera may face forward to provide object recognition in the vehicle path), one or more infrared cameras 134, satellite navigation system (e.g., Global Positioning System (GPS)) unit 136 that provides location coordinates, a steering sensor 138 that detects the steering angle, speed sensors 140 (one for each of the wheels), an inertial sensor or inertial measurement unit (“IU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Cameras 132 may be stereo cameras, single-lens cameras, or other types of cameras. Other sensors may be used, as is known to persons of ordinary skill in the art.

Controller system 114 may also receive inputs from an instrument cluster 148 and may provide human-perceptible outputs to a human operator via one or more human-machine interface (“HMI”) displays 150, an audible annunciator, a loudspeaker and/or other means. In addition to traditional information such as velocity, time, and other well-known information, one or more of HMI displays 150 may provide the vehicle occupants with information regarding maps and vehicle's location, the location of other vehicles (including an occupancy grid) and the identification of objects and status. For example, one or more of HMI displays 150 may alert the passenger when controller system 114 has identified the presence of a stop sign, caution sign, or changing traffic light and is taking appropriate action, giving the vehicle occupants peace of mind that controller system 114 is functioning as intended. In one example, instrument cluster 148 includes a separate controller/processor configured to perform deep learning and artificial intelligence functionality.

Vehicle 102 may collect data that are used to help train and refine neural networks used for autonomous driving. Vehicle 102 may include a modem 152, preferably a system-on-a-chip that provides modulation and demodulation functionality and allows controller system 114 to communicate over a wireless network 154. Modem 152 may include an radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 may include wireless functionality substantially compliant with one or more wireless protocols such as, without limitation: LTE, WCDMA, UMTS, GSM, CDMA2000, or other known and widely used wireless protocols.

Vehicle 102 may include a plurality of cameras 130-134 configured to capture images around the entire periphery of vehicle 102. Camera type and lens selection may depend on the nature and type of function. Vehicle 102 may have a mix of camera types and lenses to provide complete coverage around vehicle 102. In general, narrow lenses do not have a wide field of view but can see farther. All camera locations on vehicle 102 may support interfaces such as Gigabit Multimedia Serial link (GMSL) and Gigabit Ethernet.

As was described above, vehicle 102 may be configured with sensors that provide access to a 360-degree surround representation of the environment for safe and efficient navigation. A multi-camera sensor and depth sensor system may be configured to reliably capture a complete surrounding representation around vehicle 102 by aggregating pixel level information from cameras 130-134 with depth, geometry, and/or velocity information from a depth sensor. In addition, though not shown in FIG. 1, other example depth sensors may be used in conjunction with the techniques of this disclosure, including infrared depth sensors, structured light sensors, and/or time-of-flight (ToF) camera sensors.

Controller system 114 may obtain point cloud data comprising coordinate data for a plurality of points. The point cloud data may be generated based on data from a LIDAR system. For each point of the plurality of points, the coordinate data for the point indicates of a position of the point relative to a first origin point, and a distance of the point from the first origin point is less than a first distance threshold. Additionally, controller system 114 may initialize a plurality of second origin points. For each second origin point of the plurality of second origin points, controller system 114 may identify a point subset for the second origin point. As at least part of identifying the point subset for the second origin point, controller system 114 may, for each point of the plurality of points, identify the point as being in the point subset for the second origin point based on a distance of the point from a second origin point being less than a second distance threshold. The second distance threshold is less than the first distance threshold.

Additionally, for each second origin point of the plurality of second origin points, controller system 114 may modify the points in the point subset for the second origin point so that the coordinate data for the points in the point subset for the second origin point indicate the positions of the points in the point subset for the second origin point relative to the second origin point instead of the first origin point. Controller system 114 may apply an object recognition model to the modified points in the point subset for the second origin point to generate object labels for the modified points in the point subset for the second origin point. Controller system 114 may then generate an aggregated label map based on the object labels for modified points in the point subsets for the plurality of second origin points. By using point subsets in this way, controller system 114 may be able to use an object recognition model that is trained to generate object labels for point clouds having maximum distances less than or equal to the second distance threshold.

Controller system 114 may perform an action based on the aggregated label map. For example, controller system 114 may cause vehicle 102 to accelerate, decelerate, or turn.

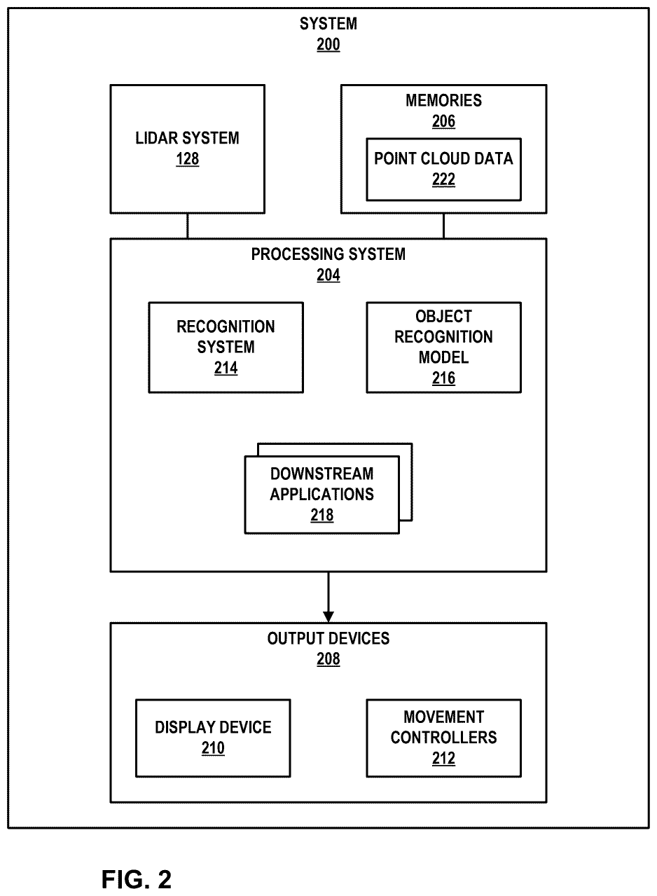

FIG. 2 is a block diagram illustrating an example system 200 that includes LIDAR system 128, a processing system 204, one or more memories 206, and one or more output devices 208, in accordance with one or more techniques of this disclosure. In various examples, system 200 may be part of a vehicle, smartphone, mobile device, computing device, robot, or other type of device. Example types of vehicles include cars, trucks, boats, ships, unmanned aerial vehicles, aircraft, spacecraft, and so on. In some examples, LIDAR system 128, processing system 204, memories 206, and output devices 208 are included in, or attached to, the same physical device. In some examples, one or more of LIDAR system 128, processing system 204, memories 206, and output devices 208 may be included in, or attached to, two or more physical devices. For instance, LIDAR system 128 and processing system 204 may be in a first device of system 200 and output devices 208 may be in a second device of system 200.

Processing system 204 comprises one or more discrete hardware units within system 200. For example, processing system 204 may include a modular, self-contained unit of hardware within system 200. In different examples, processing system 204 may or may not be connected to a motherboard shared with processing system 204. In some instances, this disclosure may refer to processing system 204 as a “core.” A role of processing system 204 is to preprocess image data generated by sensors (e.g., LIDAR system 128) prior to use of the image data by processing system 204. Examples of preprocessing the image data may include harmonizing characteristics of image data across sensors, synchronizing image data, regularizing illumination levels across sensors, correcting for lens distortion, increase gain at corners of images, and other tasks that ready the image data for use by processing system 204. Processing system 204 may be part of a larger pipeline for processing image data. With respect to the example of FIG. 1, controller system 114 may include processing system 204.

Processing system 204 may include one or more processing units (i.e., processors). In some examples, processing system 204 may include a pipeline of processors. In some examples, processing system 204 obtains image data that has been preprocessed by processing system 204. Processing system 204 may use the image data for one or more purposes. In some examples, processing system 204 may apply one or more filters to the image data. In an example where system 200 is a vehicle or robot, processing system 204 may use the image data for navigation. In accordance with techniques of this disclosure, processing system 204 may obtain point cloud data based on data generated from LIDAR system 128. In some examples, to obtain the point cloud data, controller system 114 may process data from LIDAR system 128 to generate the point cloud data. In some examples, to obtain the point cloud data, controller system 114 may directly receive the point cloud data from LIDAR system 128. With reference to FIG. 1, controller system 114 may include processing system 204.

Memories 206 may include one or more non-transitory computer-readable media. In some examples, memories 206 may be configured to store point cloud data 222. Processing system 204 may obtain point cloud data 222 from memories 206 and store generated or received point cloud data 222 to memories 206.

Processing system 204 may cause output devices 208 to produce various types of output. For instance, in the example of FIG. 2, output devices 208 include a display device 210. Processing system 204 may cause display device 210 to display images and/or video based on the image data generated by one or more of sensors. Additionally, in the example of FIG. 2, output devices 208 may include one or more movement controllers 212. Movement controllers 212 may perform actions to move system 200. For instance, in examples system 200 is a vehicle, movement controllers 212 may steer, accelerate, or brake the vehicle. In an example where system 200 is a robot, movement controllers 212 may cause different portions of the robot to move in particular ways. It is to be understood that display device 210 and movement controllers 212 are provided in FIG. 2 as examples of output devices 208 and not all examples include either or both display device 210 and movement controllers 212, and that output devices 208 may include other types of devices and systems. In some examples, one or more of controllers 114 include movement controllers 212.

Processing system 204 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

In the example of FIG. 2, processing system 204 includes a recognition system 214, an object recognition model 216, and one or more downstream applications 218. Recognition system 214 and downstream applications 218 may be associated with processor-executable instructions that are executable by processors of processing system 204. Execution of such instructions by the one or more processors may cause the processing system 204 to provide the functionality ascribed in this disclosure to recognition system 214 and downstream applications 218. In some examples, some or all functionality of recognition system 214 and/or downstream applications 218 is provided by special-purpose processors of processing system 204.

Recognition system 214 may obtain point cloud data comprising coordinate data for a plurality of points. The point cloud data may be generated based on data from LIDAR system 128. For each point of the plurality of points, the coordinate data for the point indicates of a position of the point relative to a first origin point, and a distance of the point from the first origin point is less than a first distance threshold.

Additionally, recognition system 214 may initialize a plurality of second origin points. For each second origin point of the plurality of second origin points, controller system 114 may identify a point subset for the second origin point.

As at least part of identifying the point subset for the second origin point, recognition system 214 may, for each point of the plurality of points, identify the point as being in the point subset for the second origin point based on a distance of the point from a second origin point being less than a second distance threshold. The second distance threshold is less than the first distance threshold. In other words, recognition system 214 may identify smaller point clouds (point subsets) within the initial point cloud.

In some examples, after identifying a point subset for a second origin point, recognition system 214 may dynamically adapt the density of points in the point subset for the second origin point. In many circumstances, the density of points decreases with greater distance from LIDAR system 128. This may increase the likelihood of object recognition model 216 applying erroneous labels to points. Additionally, if object recognition model 216 is trained using data from a lower-range LIDAR system and the obtained point cloud data is generated based on data from a longer-range LIDAR system, the density of points close to the longer-range LIDAR system may be greater than expected by object recognition model 216, which may also increase the likelihood of object recognition model 216 applying erroneous labels to points. To compensate, recognition system 214 may upsample or downsample points in the point subset for the second origin point.

Thus, in some examples, recognition system 214 may estimate a density of points in the point subset for the second origin point. To estimate the density of points in the point subset for the second origin point, recognition system 214 may divide the number of points in the point subset for the second origin point by a volume of a region associated with the second origin point. The region associated with the second origin point may be a 3-dimensional space (e.g., sphere, cube, etc.) associated with the second origin point. The 3-dimensional space may be defined based on the second threshold distance. For instance, in an example where the 3-dimensional space is a sphere, the 3-dimensional space may have a radius equal to the second threshold distance. The volume of the region associated with the second origin point may be an amount of space within the region associated with the second origin point.

Additionally, as part of a process of determining whether to upsample or downsample points in the point subset for the second origin point, recognition system 214 may calculate a density ratio based on a reference density and the estimated density of points in the point subset for the second origin point. The reference density may be an average point density of points in training data used to train object recognition model 216. For example, recognition system 214 may calculate the reference density based on an average number of points in training data sets used to train object recognition model 216 divided by a volume of a space containing the points in the training data sets. Thus, the density ratio may be calculated as the estimated density of the points in the point subset for the second origin point divided by the reference density.

Recognition system 214 may determine, based on the density ratio, whether to upsample, downsample, or retain the points in the point subset for the second origin point. For example, recognition system 214 may upsample the points in the point subset for the second origin point if the density ratio is greater than 1+ε, where ε is a value greater than or equal to 0. ε may be configurable. Recognition system 214 may downsample the points in the point subset for the second origin point if the density ratio is less than 1−ε. If the density ratio is less than 1+ε and greater than 1−ε, recognition system 214 may either retain the points in the point subset for the second origin point without upsampling or downsampling the points in the point subset for the second origin point.

Recognition system 214 may use one of several techniques to upsample the points in the point subset for the second origin point. For example, recognition system 214 may use a random perturbation technique in which points are duplicated, and random spatial shifts are applied to the duplicated points. In some examples, recognition system 214 may use an interpolation technique in which points are added between existing points in the point subset for the second origin point. In some examples, recognition system 214 may use a holistic upsampling technique in which geometric information is used to perform a zero-shot point could upsampling.

Recognition system 214 may use one of several techniques to downsample the points in the point subset for the second origin point. For example, recognition system 214 may use a farthest point sampling technique in which points maximally distant from each other are selected to preserve a geometric structure. In another example, recognition system 214 may use a voxel grid downsampling technique in which recognition system 214 partitions the space into voxels and preserves only a single representative point within each of the voxels. In some examples, recognition system 214 may use sensor configuration matching and ray casting to downsample the points in the point subset for the second origin point. Thus, in this example, recognition system 214 may adjust the point subset to mimic angular resolution, field of view and beam distribution of the short-range LIDAR sensor. Recognition system 214 may then cast rays from the sensor origin through the point cloud using the new angular resolutions, select and keep nearest point that intersects with each ray path.

In some examples, recognition system 214 may calculate a number of points to be generated or removed by multiplying the number of points in the point subset for the second origin point by the density ratio. In such examples, if recognition system 214 is upsampling the points, recognition system 214 may generate new points based on the existing points in the point subset, where the number of new points is number of number of points to be generated minus the number of points in the point subset. If recognition system 214 is downsampling the points, recognition system 214 may reduce the number of points in the point subset by the calculated number of points.

In accordance with one or more techniques of this disclosure, recognition system 214 may update the plurality of second origin points to increase an aggregate coverage region of the second origin points within a coverage region of the first origin point. For example, recognition system 214 may update the plurality of second origin points to maximize coverage regions associated with the plurality of second origin points and minimize a quantity of the plurality of second origin points. That is, in some examples, recognition system 214 may adjust the quantity and positions of the second origin points so that the point subsets for the second origin points include as many points of the point cloud data as possible (if not all points of the point cloud data) while keeping a total quantity of the second origin points down. Example techniques for updating the plurality of second origin points are provided in greater detail elsewhere in this disclosure.

Additionally, for each second origin point of the plurality of second origin points, recognition system 214 may modify the points in the point subset for the second origin point so that the coordinate data for the points in the point subset for the second origin point indicate the positions of the points in the point subset for the second origin point relative to the second origin point instead of the first origin point. Recognition system 214 may apply object recognition model 216 to the modified points in the point subset for the second origin point to generate object labels for the modified points in the point subset for the second origin point. Object recognition model 216 may be implemented using one or more neural network models. Examples of object recognition models are described in Chen et al., “FocalFormer3D: Focusing on Hard Instance for 3D Object Detection,” arXiv:2308.04556v1 [cs.CV]8 Aug. 2023; Mei et al., “SEGT: A General Spatial Expansion Group Transformer for nuScenes Lidar-based Object Detection Task,” arXiv:2412.09658v2 [cs.CV]21 Jan. 2025; Lang et al., “PointPillars: Fast Encoders for Object Detection from Point Clouds,” arXiv:1812.05784v2 [cs.LG]7 May 2019; Zhou et al., “VoxelNet: End-to-End Learning for Point Cloud Based 3D Object Detection,” arXiv:1711.06396v1 [cs.CV]17 Nov. 2017; Zimmer et al., “A Survey of Robust LiDAR-based 3D Object Detection Methods for Autonomous Driving,” rXiv:2204.00106v1 [cs.CV]31 Mar. 2022; and Liu et al., “Point Transformer V3: Simpler, Faster, Stronger,” arXiv:2312.10035v2 [cs.CV]25 Mar. 2024.

Recognition system 214 may then generate an aggregated label map based on the object labels for the modified points in the point subsets for the plurality of second origin points. For example, after generating the object labels for the modified points in a point subset, recognition system 214 may convert the coordinate data of the modified points in the point subset so that the coordinate data again indicate positions relative to the first origin point. The aggregated label map may be an aggregation of points in the point subsets after converting the coordinate data of the points of the point subsets back to indicating positions relative to the first origin point.

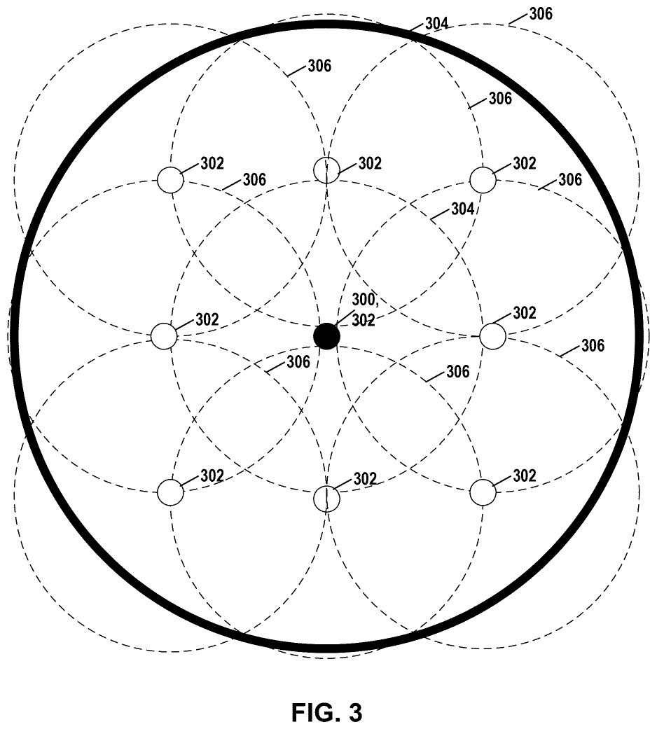

FIG. 3 is a conceptual diagram illustrating example coverages regions associated with a first origin point 300 and a plurality of second origin points 302, in accordance with one or more techniques of this disclosure. Note that one of second origin points 302 may be co-located with first origin point 300. In the example of FIG. 3, a coverage region 304 associated with first origin point 300 is shown as a solid-line circle. Coverage regions 306 associated with second origin points 302 are shown as dashed-line circles. While the positions of second origin points 302 are generally symmetrical in the example of FIG. 3, this may not be the case in all examples. For instance, if the point cloud data does not include any points in some spaces within the coverage region 304 associated with first origin point 300, there may be no need for a coverage region associated with a second origin point to cover such spaces. Not having a coverage region associated with a second origin point cover such spaces may help to minimize a total quantity of the second origin points 302, which may reduce demand on computational resources during the process of using object recognition model 216 to apply labels to points. Although shown as 2-dimensional circles in the example of FIG. 3, the coverage region associated with first origin point 300 and coverage regions 306 associated with second origin points 302 may be 3-dimensional shapes, such as spheres, hemispheres, cubes, or other 3-dimensional shapes.

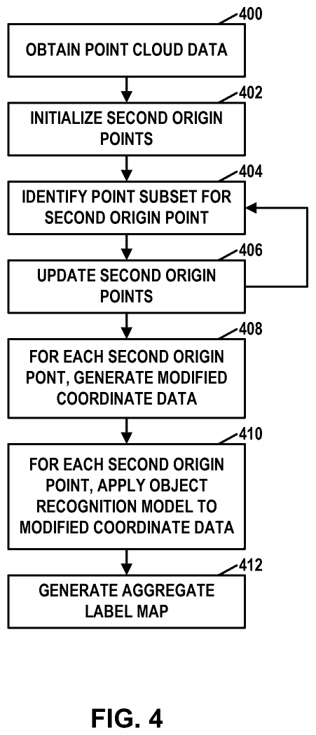

FIG. 4 is a flowchart illustrating an example operation of recognition system 214 configured in accordance with one or more techniques of this disclosure. In the example of FIG. 4, recognition system 214 may obtain point cloud data comprising coordinate data for a plurality of points (400). The point cloud data may be generated based on data from LIDAR system 128. The points may correspond to locations from which LIDAR system 128 detected a reflection of light emitted by LIDAR system 128. For each point of the plurality of points, the coordinate data for the point may indicate of a position of the point relative to a first origin point. For each point of the plurality of points, a distance of the point from the first origin point is less than a first distance threshold. In other words, a distance from the first origin point to the point is less than the first distance threshold. For example, the points may be within a sphere centered on the first origin point that has a radius equal to the first distance threshold.

Additionally, recognition system 214 may initialize a plurality of second origin points (402). In some examples, recognition system 214 may initialize the plurality of second origin points randomly within a volume defined by the first distance threshold. In some examples, recognition system 214 may initialize the plurality of second origin points based on positions of second origin points in a previous processing cycle. That is, recognition system 214 may perform the operation of FIG. 4 for successive sets of point cloud data as LIDAR system 128 continues to provide more data over time. In this example, the positions of the second origin points may be initialized to be the same as the second origin points used in the previous processing cycle.

Recognition system 214 the plurality of second origin points may initially include a default quantity of second origin points. In some examples, recognition system 214 may determine the default quantity of second origin points based on a relationship between the first distance threshold and a second distance threshold. For instance, if the second distance threshold is relatively small as compared to the first distance threshold, the default quantity of second origin points may be greater than if the second distance threshold is relatively great as compared to the first distance threshold.

For each second origin point of the plurality of second origin points, recognition system 214 may identify a point subset for the second origin point (404). For each point of the plurality of points, recognition system 214 may identify the point as being in the point subset for the second origin point based on a distance of the point from the second origin point being less than the second distance threshold. The second distance threshold is less than the first distance threshold. For example, the second distance threshold may be 50 meters and the first distance threshold may be 100 meters.

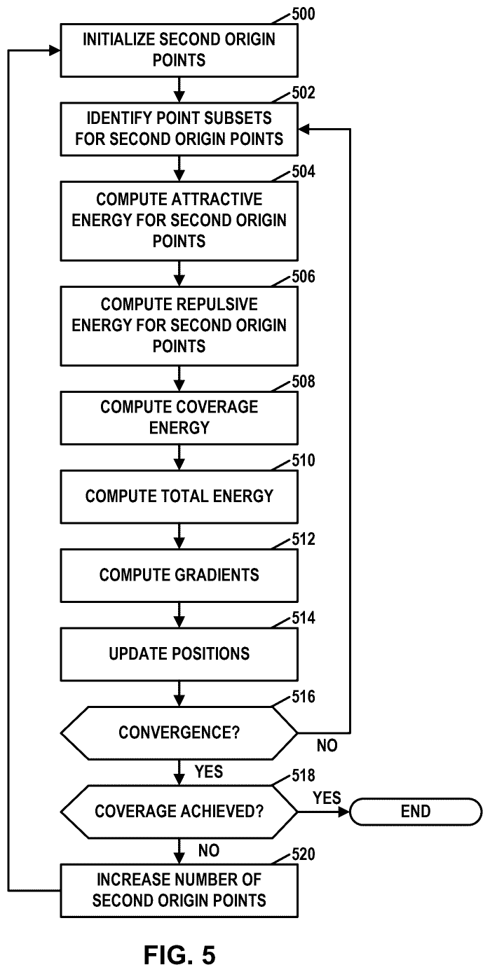

Recognition system 214 may update the plurality of second origin points to increase an aggregate coverage region of the second origin points within a coverage region of the first origin point (406). For example, recognition system 214 may update the plurality of second origin points to maximize coverage regions associated with the plurality of second origin points and minimize a quantity of the plurality of second origin points. FIG. 5, which is described in greater detail below, described an example process for updating the plurality of second origin points.

Additionally, for each second origin point of the plurality of second origin points, recognition system 214 may modify the points in the point subset for the second origin point so that the coordinate data for the points in the point subset for the second origin point indicate the positions of the points in the point subset for the second origin point relative to the second origin point instead of the first origin point (408). For example, a position of each point in the point cloud data may be defined in term of a set of spherical coordinates (r₁, θ₁, φ₁) in a first spherical coordinate system where (0,0,0) corresponds to the first origin point. Recognition system 214 may modify the spherical coordinates of the point to spherical coordinates (r₂, θ₂, φ₂) in a second spherical coordinate system where (0,0,0) corresponds to the second origin point. For example, if the point has spherical coordinates (10,0,0) in the first spherical coordinate system, the second origin point has spherical coordinates (6,0,0) in the first spherical coordinate system, the modified coordinate data for the point may be (4,0,0).

For each second origin points, recognition system 214 may apply object recognition model 216 to the modified points in the point subset for the second origin point to generate object labels for the modified points in the point subset for the second origin point (410). As discussed above, object recognition model 216 may include one or more trained machine learning (ML) models that are trained to generate object labels for training data points having positions that are up to the second distance threshold from a training data origin point. The training data origin point is an origin point used in the training data. Recognition system 214 may then generate an aggregated label map based on the object labels for points in the point subsets for the plurality of second origin points (412).

Controller system 114, downstream applications 218, or other systems may perform various actions based on the aggregated label map. For example, a navigation action may be determined based on the aggregated label map. For instance, in this example, if a cluster of points in the aggregated label map are labeled as being associated with a pedestrian, the navigation action may be to avoid the pedestrian. In some examples, a sensor (e.g., LIDAR system 128) is mounted on a vehicle or robot and the vehicle or robot may be controlled (e.g., by controller system 114) based on the aggregated label map.

FIG. 5 is a flowchart illustrating an example operation for updating positions of second origin points, in accordance with one or more techniques of this disclosure. In the example of FIG. 5, recognition system 214 may initialize a plurality of second origin points (500). Recognition system 214 may initialize the plurality of second origin points in accordance with any of the examples provided above.

Recognition system 214 may then compute a total energy of the point subsets for the plurality of second origin points. To compute the total energy of the points subsets. Recognition system 214 may, for each second origin point of the plurality of second origin points, compute an attractive energy of the point subset for the second origin point (502). Recognition system 214 may compute the attractive energy as:

$${E}_{att} ( {x}_{i} ) = {k}_{att} \times {max ( 0 , ‖ {x}_{i} ‖ - ( R - r ) )}^{2}$$

xᵢ∈ [symbol] and is a position vector of the second origin point. R is a radius, such as the first threshold distance, associated with the point cloud data (e.g., 200 meters). r is radius, such as the second threshold distance, associated with the point subsets (e.g., 50 meters). kₐₜₜ is a coefficient greater than 0 that controls a strength of the attractive energy. ∥xᵢ∥ indicates Euclidean distance of the second origin point from the first origin point. The term (R−r) may ensure that the entire coverage region (including its radius r) stays within a boundary. The max function may ensure that the attractive energy is only positive when the coverage region of the second origin point extends beyond the boundary. Thus, the attribute energy of a second origin point may be conceptualized as an energy attracting the second origin point toward the first origin point.

For each second origin point of the plurality of second origin points, recognition system 214 may also compute repulsive energies of pairs of the second origin points (504). Recognition system 214 may compute the repulsive energy as:

$${E}_{rep} ( {x}_{i} , {x}_{j} ) = {k}_{rep} \times {( max ( 0 , {d}_{min} - ‖ {x}_{i} - {x}_{j} ‖ ) )}^{2}$$

kᵣₑₚ is a coefficient greater than 0 that controls a strength of the repulsive energy. dₘᵢₙ is a minimum allowable distance between second origin points before repulsion occurs. dₘᵢₙ may be slightly less than 2r to allow for minimum overlap needed for full coverage. In some examples, dₘᵢₙ=2r−δ, where δ allows for slight overlap. ∥xᵢ−xⱼ∥ is a Euclidean distance coverage between second origin points xᵢ and xⱼ. The repulsive energy may increase quadratically as the second origin points get closer than dₘᵢₙ. Thus, the repulsive energy of a pair of second origin points may be conceptualized as an energy repelling the second origin points from each other.

Recognition system 214 may compute a coverage energy of the point subsets for the plurality of second origin points (508). Recognition system 214 may compute the coverage energy as:

$${E}_{cov} = {k}_{cov} \times {\sum }_{p ∈ S} h ( p )$$

S is a set of sample points within the large coverage region defined by R.

$$h ( p ) = \{ \begin{matrix}1 , & if p is not covered by an {x}_{i} \\ 0 , & if p is covered by at least one {x}_{i}\end{matrix}$$

k_{cov}>0 is a coefficient controlling a penalty for uncovered points. In other words, for a point p, h(p) may be 1 if the point is within a coverage region of one of the second origin points (i.e., is one of the points in the point subset for the second origin points) and may be 0 if the point is not within the coverage region of any of the second origin points (i.e., not in the point subsets for any of the second origin points).

Recognition system 214 may compute the total energy based on the attractive energy, the repulsive energy, and the coverage energy of the point subsets for the second origin points (510). For example, recognition system 214 may compute the total energy according to the following total energy function:

$${E}_{total} = {\sum }_{i - 1}^{N} {E}_{att} ( {x}_{i} ) + {\sum }_{l = 1}^{N} {\sum }_{j = i + 1}^{N} {E}_{rep} ( {x}_{i} , {x}_{j} ) + {E}_{cov}$$

N is a total quantity of second origin points in the plurality of second origin points. Thus, recognition system 214 may compute the total energy based on the attractive energies of the second origin points, the repulsive energies of the pairs of second origin points, and the coverage energy of the point subsets for the plurality of the second origin points.

After computing the total energy, recognition system 214 may compute a gradient of the total energy function (512). In other words, for each respective second origin point of the plurality of second origin points, recognition system 214 may determine a direction, in the coordinate space of the point cloud data, of greatest change in the total energy function at the second origin point.

Recognition system 214 may then update positions of one or more of the second origin points based on the gradient of the total energy function (514). For example, recognition system 214 may use a gradient descent technique to update the positions of one or more of the second origin points based on the gradient of the total energy function. In some examples, recognition system 214 may use a simulated annealing technique to update the positions of one or more of the second origin points based on the gradient of the total energy function.

After updating the positions of the second origin points, recognition system 214 may determine whether one or more convergence conditions are satisfied (516). For example, recognition system 214 may determine that the one or more convergence conditions are satisfied based on the total energy being below a predetermined threshold. In some examples, the one or more convergence conditions may include whether an aggregate coverage region (which is based on coverage regions of the second origin points) covers a coverage region of the first origin point. In some examples, the one or more convergence conditions are satisfied when the total energy is below a predefined threshold. The aggregate coverage region may be a 3-dimensional space defined by a union of the coverage regions of the second origin points. If the one or more convergence conditions are not satisfied (“NO” branch of 516), recognition system 214 may repeat steps (502) through (516) with respect to the updated second origin points.

If the one or more convergence conditions are satisfied (“YES” branch of 516), recognition system 214 may determine whether coverage has been achieved (518). For example, recognition system 214 may verify that all points in the point cloud data are within at least one of the point subsets for the plurality of second origin points. If coverage has been achieved (“YES” branch of 518), the operation of FIG. 5 may end. However, if coverage has not been achieved (“NO” branch of 518), recognition system 214 may increase the number of second origin points (520). Recognition system 214 may then repeat steps (502) through (520) until coverage is achieved.

In this way, for each processing round of one or more processing rounds, recognition system 214 may update the second origin points based on the gradients. For example, recognition system 214 may adjust the locations of one or more of the second origin points based on the gradients. Updating the second origin points based on the gradients may allow a better distribution of the second origin points given the locations of points in the point cloud data. Additionally, during the processing round, recognition system 214 may determine an aggregate coverage region based on coverage regions of the second origin points. The aggregate coverage region may be a 3-dimensional space defined by a union of the coverage regions of the second origin points.

Recognition system 214 may then determine, during the processing round, whether the aggregate coverage region satisfies one or more convergence conditions. During the processing round, recognition system 214 may adjust a quantity of the second origin points based on the determination. For example, recognition system 214 may increase the quantity of the second origin points if the aggregate coverage region is less than a predetermined percentage of a coverage region defined by the first distance threshold or another distant threshold, if the aggregate coverage region does not cover all the coverage region defined by the first distance threshold or another threshold, and so on. In some examples, recognition system 214 may decrease the quantity of the second origin points if the aggregate coverage region satisfies a first threshold and an amount of overlap among the coverage regions of the second origin points satisfies a second threshold.

Various examples of the techniques of this disclosure are summarized in the following clauses:

Clause 1. A computer-implemented method comprising: obtaining point cloud data comprising coordinate data for a plurality of points, wherein, for each point of the plurality of points: the coordinate data for the point indicates of a position of the point relative to a first origin point, and a distance of the point from the first origin point is less than a first distance threshold; initializing a plurality of second origin points, at least one of the plurality of second origin points being different from the first origin point; updating the plurality of second origin points to increase an aggregate coverage region of the second origin points within a coverage region of the first origin point; for each second origin point of the plurality of second origin points: identifying a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modifying the points in the point subset for the second origin point so that the coordinate data for the points in the point subset for the second origin point indicate the positions of the points in the point subset for the second origin point relative to the second origin point instead of the first origin point; and applying an object recognition model to the modified points in the point subset for the second origin point to generate object labels for the modified points in the point subset for the second origin point; and generating an aggregated label map based on the object labels for the modified points in the point subsets for the plurality of second origin points.

Clause 2. The computer-implemented method of clause 1, wherein the object recognition model includes one or more trained machine learning (ML) models that are trained to generate object labels for training data points having positions that are up to the second distance threshold from a training data origin point.

Clause 3. The computer-implemented method of any of clauses 1-2, wherein updating the plurality of second origin points comprises, for one or more processing rounds: computing a total energy of the point subsets for the plurality of second origin points; computing gradients of the total energy with respect to each of the second origin points; updating the second origin points based on the gradients; determining the aggregate coverage region based on coverage regions of the second origin points; determining whether the aggregate coverage region satisfies one or more convergence conditions; and adjusting a quantity of the second origin points based on the determination.

Clause 4. The computer-implemented method of clause 3, wherein computing the total energy comprises: for each second origin point of the plurality of second origin points, computing an attractive energy of the point subset for the second origin point; computing repulsive energies of pairs of the second origin points; and computing a coverage energy of the point subsets for the plurality of second origin points; and computing the total energy based on the attractive energies of the second origin points, the repulsive energies of the pairs of second origin points, and the coverage energy of the point subsets for the plurality of the second origin points.

Clause 5. The computer-implemented method of any of clauses 1-4, for at least one second origin point of the plurality of second origin points: estimating a density of points in the point subset for the at least one second origin point; calculating a density ratio based on a reference density and the estimated density of points in the point subset for the at least one second origin point, wherein the reference density is an average point density of points in training data used to train the object recognition model; and determining, based on the density ratio, whether to upsample, downsample, or retain the points in the point subset for the at least one second origin point.

Clause 6. The computer-implemented method of any of clauses 1-5, further comprising determining a navigation action based on the aggregated label map.

Clause 7. The computer-implemented method of any of clauses 1-6, wherein obtaining the point cloud data comprises obtaining the point cloud data from a sensor.

Clause 8. The computer-implemented method of clause 7, wherein the sensor is a LIDAR sensor.

Clause 9. The computer-implemented method of clause 8, wherein the sensor is mounted on a vehicle or robot and the method further comprises controlling the vehicle or robot based on the aggregated label map.

Clause 10. A system comprising: one or more memories configured to store point cloud data comprising coordinate data for a plurality of points, wherein, for each point of the plurality of points: the coordinate data for the point indicates of a position of the point relative to a first origin point, and a distance of the point from the first origin point is less than a first distance threshold; and one or more processors configured to: initialize a plurality of second origin points, at least one of the plurality of second origin points being different from the first origin point; update the plurality of second origin points to increase an aggregate coverage region of the second origin points within a coverage region of the first origin point; for each second origin point of the plurality of second origin points: identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modify the points in the point subset for the second origin point so that the coordinate data for the points in the point subset for the second origin point indicate the positions of the points in the point subset for the second origin point relative to the second origin point instead of the first origin point; and apply an object recognition model to the modified points in the point subset for the second origin point to generate object labels for the modified points in the point subset for the second origin point; and generate an aggregated label map based on the object labels for the modified points in the point subsets for the plurality of second origin points.

Clause 11. The system of clause 10, wherein the object recognition model includes one or more trained machine learning (ML) models that are trained to generate object labels for training data points having positions that are up to the second distance threshold from a training data origin point.

Clause 12. The system of any of clauses 10-11, wherein the one or more processors are configured to, as at least part of updating the plurality of second origin points, for one or more processing rounds: for each second origin point of the plurality of second origin points, compute an attractive energy of the point subset for the second origin point; compute repulsive energies of pairs of the second origin points; and compute a coverage energy of the point subsets for the plurality of second origin points; compute a total energy based on the attractive energies of the second origin points, the repulsive energies of the pairs of second origin points, and the coverage energy of the point subsets for the plurality of the second origin points; compute gradients of the total energy with respect to each of the second origin points; update the second origin points based on the gradients; determine the aggregate coverage region based on coverage regions of the second origin points; determine whether the aggregate coverage region satisfies one or more convergence conditions; and adjust a quantity of the second origin points based on the determination.

Clause 13. The system of any of clauses 10-12, wherein the one or more processors are configured to, for at least one second origin point of the plurality of second origin points: estimate a density of points in the point subset for the at least one second origin point; calculate a density ratio based on a reference density and the estimated density of points in the point subset for the at least one second origin point, wherein the reference density is an average point density of points in training data used to train the object recognition model; and determine, based on the density ratio, whether to upsample, downsample, or retain the points in the point subset for the at least one second origin point.

Clause 14. The system of any of clauses 10-13, wherein the one or more processors are further configured to determine a navigation action based on the aggregated label map.

Clause 15. The system of any of clauses 10-14, further comprising a LIDAR sensor, wherein the one or more processors are configured to obtain the point cloud data based on data from the LIDAR sensor.

Clause 16. The system of clause 15, wherein the LIDAR sensor is mounted on a vehicle or robot and the one or more processors are further configured to control the vehicle or robot based on the aggregated label map.

Clause 17. The system of any of clauses 10-16, wherein the one or more processors are further configured to, as part of generating the aggregated label map, convert the coordinate data of the modified points back so that the coordinate data of the modified points again indicates the positions of the points relative to the first origin point.

Clause 18. One or more non-transitory computer-readable storage media having instructions stored thereon that, when executed by one or more processors, cause the one or more processors to: obtain point cloud data comprising coordinate data for a plurality of points, wherein, for each point of the plurality of points: the coordinate data for the point indicates of a position of the point relative to a first origin point, and a distance of the point from the first origin point is less than a first distance threshold; initialize a plurality of second origin points, at least one of the plurality of second origin points being different from the first origin point; update the plurality of second origin points to increase an aggregate coverage region of the second origin points within a coverage region of the first origin point; for each second origin point of the plurality of second origin points: identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold; modify the points in the point subset for the second origin point so that the coordinate data for the points in the point subset for the second origin point indicate the positions of the points in the point subset for the second origin point relative to the second origin point instead of the first origin point; and apply an object recognition model to the modified points in the point subset for the second origin point to generate object labels for the modified points in the point subset for the second origin point; and generate an aggregated label map based on the object labels for the modified points in the point subsets for the plurality of second origin points.

Clause 19. The one or more non-transitory computer-readable storage media of clause 18, wherein the object recognition model includes one or more trained machine learning (ML) models that are trained to generate object labels for training data points having positions that are up to the second distance threshold from a training data origin point.

Clause 20. The one or more non-transitory computer-readable storage media of any of clauses 18-19, wherein the instructions cause the one or more processors to, for at least one second origin point of the plurality of second origin points: estimate a density of points in the point subset for the at least one second origin point; calculate a density ratio based on a reference density and the estimated density of points in the point subset for the at least one second origin point, wherein the reference density is an average point density of points in training data used to train the object recognition model; and determine, based on the density ratio, whether to upsample, downsample, or retain the points in the point subset for the at least one second origin point.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method comprising:
obtaining point cloud data comprising coordinate data for a plurality of points, wherein, for each point of the plurality of points:
the coordinate data for the point indicates of a position of the point relative to a first origin point, and
a distance of the point from the first origin point is less than a first distance threshold;
initializing a plurality of second origin points, at least one of the plurality of second origin points being different from the first origin point;
updating the plurality of second origin points to increase an aggregate coverage region of the second origin points within a coverage region of the first origin point;
for each second origin point of the plurality of second origin points:
identifying a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold;
modifying the points in the point subset for the second origin point so that the coordinate data for the points in the point subset for the second origin point indicate the positions of the points in the point subset for the second origin point relative to the second origin point instead of the first origin point; and
applying an object recognition model to the modified points in the point subset for the second origin point to generate object labels for the modified points in the point subset for the second origin point; and
generating an aggregated label map based on the object labels for the modified points in the point subsets for the plurality of second origin points.

2. The computer-implemented method of claim 1, wherein the object recognition model includes one or more trained machine learning (ML) models that are trained to generate object labels for training data points having positions that are up to the second distance threshold from a training data origin point.

3. The computer-implemented method of claim 1, wherein updating the plurality of second origin points comprises, for one or more processing rounds:
computing a total energy of the point subsets for the plurality of second origin points;
computing gradients of the total energy with respect to each of the second origin points;
updating the second origin points based on the gradients;
determining the aggregate coverage region based on coverage regions of the second origin points;
determining whether the aggregate coverage region satisfies one or more convergence conditions; and
adjusting a quantity of the second origin points based on the determination.

4. The computer-implemented method of claim 3, wherein computing the total energy comprises:
for each second origin point of the plurality of second origin points, computing an attractive energy of the point subset for the second origin point;
computing repulsive energies of pairs of the second origin points; and
computing a coverage energy of the point subsets for the plurality of second origin points; and
computing the total energy based on the attractive energies of the second origin points, the repulsive energies of the pairs of second origin points, and the coverage energy of the point subsets for the plurality of the second origin points.

5. The computer-implemented method of claim 1, for at least one second origin point of the plurality of second origin points:
estimating a density of points in the point subset for the at least one second origin point;
calculating a density ratio based on a reference density and the estimated density of points in the point subset for the at least one second origin point, wherein the reference density is an average point density of points in training data used to train the object recognition model; and
determining, based on the density ratio, whether to upsample, downsample, or retain the points in the point subset for the at least one second origin point.

6. The computer-implemented method of claim 1, further comprising determining a navigation action based on the aggregated label map.

7. The computer-implemented method of claim 1, wherein obtaining the point cloud data comprises obtaining the point cloud data from a sensor.

8. The computer-implemented method of claim 7, wherein the sensor is a LIDAR sensor.

9. The computer-implemented method of claim 8, wherein the sensor is mounted on a vehicle or robot and the method further comprises controlling the vehicle or robot based on the aggregated label map.

10. A system comprising:
one or more memories configured to store point cloud data comprising coordinate data for a plurality of points, wherein, for each point of the plurality of points:
the coordinate data for the point indicates of a position of the point relative to a first origin point, and
a distance of the point from the first origin point is less than a first distance threshold; and
one or more processors configured to:
initialize a plurality of second origin points, at least one of the plurality of second origin points being different from the first origin point;
update the plurality of second origin points to increase an aggregate coverage region of the second origin points within a coverage region of the first origin point;
for each second origin point of the plurality of second origin points:
identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold;
modify the points in the point subset for the second origin point so that the coordinate data for the points in the point subset for the second origin point indicate the positions of the points in the point subset for the second origin point relative to the second origin point instead of the first origin point; and
apply an object recognition model to the modified points in the point subset for the second origin point to generate object labels for the modified points in the point subset for the second origin point; and
generate an aggregated label map based on the object labels for the modified points in the point subsets for the plurality of second origin points.

11. The system of claim 10, wherein the object recognition model includes one or more trained machine learning (ML) models that are trained to generate object labels for training data points having positions that are up to the second distance threshold from a training data origin point.

12. The system of claim 10, wherein the one or more processors are configured to, as at least part of updating the plurality of second origin points, for one or more processing rounds:
for each second origin point of the plurality of second origin points, compute an attractive energy of the point subset for the second origin point;
compute repulsive energies of pairs of the second origin points; and
compute a coverage energy of the point subsets for the plurality of second origin points;
compute a total energy based on the attractive energies of the second origin points, the repulsive energies of the pairs of second origin points, and the coverage energy of the point subsets for the plurality of the second origin points;
compute gradients of the total energy with respect to each of the second origin points;
update the second origin points based on the gradients;
determine the aggregate coverage region based on coverage regions of the second origin points;
determine whether the aggregate coverage region satisfies one or more convergence conditions; and
adjust a quantity of the second origin points based on the determination.

13. The system of claim 10, wherein the one or more processors are configured to, for at least one second origin point of the plurality of second origin points:
estimate a density of points in the point subset for the at least one second origin point;
calculate a density ratio based on a reference density and the estimated density of points in the point subset for the at least one second origin point, wherein the reference density is an average point density of points in training data used to train the object recognition model; and
determine, based on the density ratio, whether to upsample, downsample, or retain the points in the point subset for the at least one second origin point.

14. The system of claim 10, wherein the one or more processors are further configured to determine a navigation action based on the aggregated label map.

15. The system of claim 10, further comprising a LIDAR sensor, wherein the one or more processors are configured to obtain the point cloud data based on data from the LIDAR sensor.

16. The system of claim 15, wherein the LIDAR sensor is mounted on a vehicle or robot and the one or more processors are further configured to control the vehicle or robot based on the aggregated label map.

17. The system of claim 10, wherein the one or more processors are further configured to, as part of generating the aggregated label map, convert the coordinate data of the modified points back so that the coordinate data of the modified points again indicates the positions of the points relative to the first origin point.

18. One or more non-transitory computer-readable storage media having instructions stored thereon that, when executed by one or more processors, cause the one or more processors to:
obtain point cloud data comprising coordinate data for a plurality of points, wherein, for each point of the plurality of points:
the coordinate data for the point indicates of a position of the point relative to a first origin point, and
a distance of the point from the first origin point is less than a first distance threshold;
initialize a plurality of second origin points, at least one of the plurality of second origin points being different from the first origin point;
update the plurality of second origin points to increase an aggregate coverage region of the second origin points within a coverage region of the first origin point;
for each second origin point of the plurality of second origin points:
identify a point subset for the second origin point, wherein identifying the point subset for the second origin point comprises, for each point of the plurality of points, identifying the point as being in the point subset for the second origin point based on a distance of the point from the second origin point being less than a second distance threshold, wherein the second distance threshold is less than the first distance threshold;
modify the points in the point subset for the second origin point so that the coordinate data for the points in the point subset for the second origin point indicate the positions of the points in the point subset for the second origin point relative to the second origin point instead of the first origin point; and
apply an object recognition model to the modified points in the point subset for the second origin point to generate object labels for the modified points in the point subset for the second origin point; and
generate an aggregated label map based on the object labels for the modified points in the point subsets for the plurality of second origin points.

19. The one or more non-transitory computer-readable storage media of claim 18, wherein the object recognition model includes one or more trained machine learning (ML) models that are trained to generate object labels for training data points having positions that are up to the second distance threshold from a training data origin point.

20. The one or more non-transitory computer-readable storage media of claim 18, wherein the instructions cause the one or more processors to, for at least one second origin point of the plurality of second origin points:
estimate a density of points in the point subset for the at least one second origin point;
calculate a density ratio based on a reference density and the estimated density of points in the point subset for the at least one second origin point, wherein the reference density is an average point density of points in training data used to train the object recognition model; and
determine, based on the density ratio, whether to upsample, downsample, or retain the points in the point subset for the at least one second origin point.
